(19) United States
(12) Patent Application Publication
(10) Pub. No.: US 2005/0133231 A1
(43) Pub. Date: Jun. 23, 2005

(54) Apparatus and method for storing electronics

(76) Inventor: James Conerton, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/741,822

(22) Filed: Dec. 19, 2003

(51) Int. Cl. H01H 9/02

(52) U.S. Cl. 174/17 VA

(57) ABSTRACT

An air-ventilated apparatus for storing, managing and displaying electronic equipment and devices, wherein vent cutouts are provided for cable management and for convectively cooling the stored electronic devices.

### TECHNICAL FIELD

The present invention relates generally to furniture, and more specifically to an air ventilated apparatus for storing and/or displaying electronic devices, wherein the apparatus provides vent cutouts for cable management and for convectively cooling electronic devices stored therein.

### BACKGROUND OF THE INVENTION

With the innovation and development of electronic multimedia devices, the current trend amongst consumers is to integrate a variety of such electronic audio-visual devices into home entertainment systems. Audio equipment, such as radio tuners, cassette players, compact disc (CD) players and recorders, MP3 players, and surround sound systems with speakers, are commonly incorporated into entertainment systems. Video cassette recorders (VCRs), digital video disc (DVD) players and recorders, cable boxes, satellite dishes, video games, laptop computers and various other electronic visual accessories and equipment are also commonly utilized in association with television monitors.

Various structures are available for facilitating the management, storage and organization of such audio-visual equipment and accessories. Unfortunately, due to the inherent release of heat from such electronic devices, and the relatively confined area of the structure in which the electronic devices may reside, overheating of the electronic devices often occurs, and thus, the electronic failure of same.

Accordingly, numerous structures for storing and displaying electronics have been developed in an attempt to thermally control the internal environment of the structure, and thus reduce overheating of electronic equipment housed therein. Many such structures, however, are often wide open shelves that do not enclose or conceal the electronic devices, thereby exposing them to dust, heat from direct sunlight, and other elements that may affect equipment performance or operation. Still other structures, utilize electric fans to vent out or expel warm air from within the structure. Although advantageous, electric fans are often overly expensive, require an energy source, and are a source of noise in a system where optimal sound quality is of the utmost significance. Electric fans are also susceptible to electrical failure or breakage, and can be costly or difficult to repair or replace.

The combination of multiple electronic devices also results in multiple wires and/or cables to connect and power the electronic devices. Unfortunately, and in view of available storage units, cables and wires often become entangled with one another, resulting in a clutter of wires and cables, and presenting a potential electrical hazard.

Therefore, it is readily apparent that there is a need for an apparatus for storing, organizing and/or displaying electronic equipment, wherein cables and wires are accordingly managed, and wherein the internal environment of the apparatus is appropriately thermally cooled to prevent overheating of the electronic devices stored therein.

### BRIEF SUMMARY OF THE INVENTION

Briefly described, in a preferred embodiment, the present invention overcomes the above-mentioned disadvantages and meets the recognized need for such a device by providing an air-ventilated apparatus for storing, managing and displaying electronic equipment and devices, wherein vent cutouts are provided for cable management and for convectively cooling the stored electronic devices.

According to its major aspects and broadly stated, the present invention in its preferred form is an apparatus for storing, managing and displaying electronic equipment and devices, generally comprising a base member, cabinet member and hutch member. More specifically, the present invention comprises a cabinet member for storing and/or displaying electronic devices, wherein lower cutouts are disposed on a bottom front portion of the cabinet member, and wherein upper cutouts are disposed on a top rear portion of the cabinet member to maximize convective airflow over a greater area within the cabinet member. The base member is provided to elevate the cabinet member to allow cooler, denser air to be convectively drawn into the lower cutouts, wherein the cooler air is convectively drawn over the electronic devices stored within the cabinet member to effectively cool same. More specifically, heat produced by and rising from the stored electronic devices is convectively intermixed with the cooler air introduced within the cabinet member, thereby yielding a warmer air. Thereafter, the warmer air is preferably expelled out of the cabinet member through the upper cutouts via overall convective circulation of air therewithin and therethroughout. The cabinet member also possesses shelves and a vertical divider, each having cutouts to further maximize airflow within the cabinet member.

The hutch member is provided for the storage and display of electronic devices, particularly audio speakers and a plasma display screen, wherein cooler air is convectively drawn into the hutch member through an open bottom portion, and wherein the cooler air is convectively drawn over the stored electronic devices to cool same. Warm air produced by the electronic devices is permitted to ventilate out of the hutch member through top cutouts.

Accordingly, a feature and advantage of the present invention is its ability to store, manage, display and/or conceal various electronic devices within a single apparatus and to facilitate accessibility of same.

Another feature and advantage of the present invention is its unique combination and configuration of components that permit optimal convective airflow to thermally cool stored electronic devices, thereby prolonging the life of the stored electronic devices.

Another feature and advantage of the present invention is its ability to thermally cool stored electronic devices, thereby enabling a user to incorporate a greater number of electronic devices into a smaller area.

Another feature and advantage of the present invention is its ability to thermally cool stored electronic devices without the need for conventional electric fans.

Another feature and advantage of the present invention are its ventilation cutouts that also serve as a means for managing cables and/or wires.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a front perspective view of a preferred embodiment of the present invention;

FIG. 2 is a front perspective view of a preferred embodiment of the present invention showing a cabinet member with open doors;

FIG. 3 is a top perspective view of a preferred embodiment of the present invention;

FIG. 4 is a bottom perspective view of a preferred embodiment of the present invention;

FIG. 5 is a cross-sectional view of a preferred embodiment of the present invention;

FIG. 6 is a rear perspective view of a preferred embodiment of the present invention;

FIG. 7 is a cross-sectional view of an alternate embodiment of the present invention;

FIG. 8 is a front perspective view of an alternate embodiment of the present invention;

FIG. 9 is a front perspective view of an alternate embodiment of the present invention showing a cabinet member with open doors;

FIG. 10 is a front perspective view of an alternate embodiment of the present invention, showing a projector screen in the down position;

FIG. 11 is a side perspective view of an alternate embodiment of the present invention;

FIG. 12 is a top perspective view of an alternate embodiment of the present invention;

FIG. 13 is a bottom perspective view of an alternate embodiment of the present invention;

FIG. 14 is a rear perspective view of an alternate embodiment of the present invention;

### DETAILED DESCRIPTION OF THE PREFERRED AND SELECTED ALTERNATIVE EMBODIMENTS

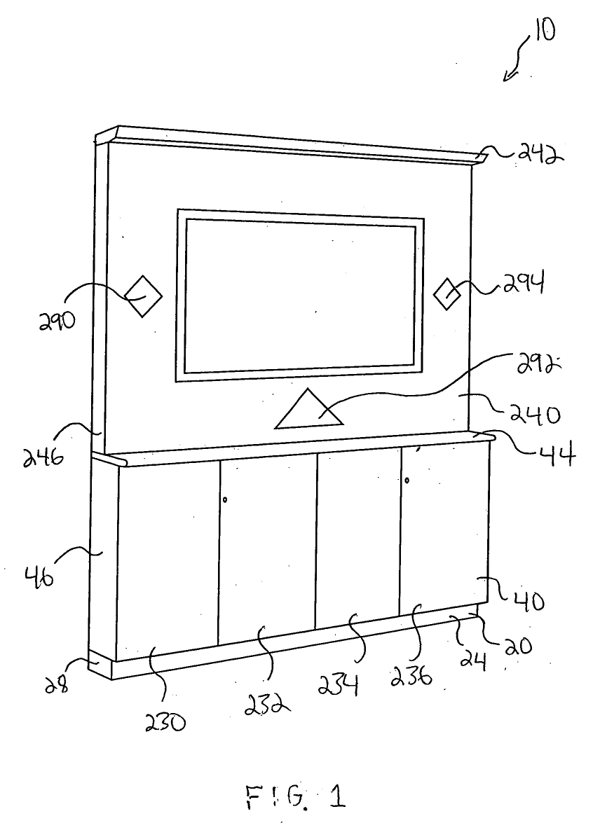

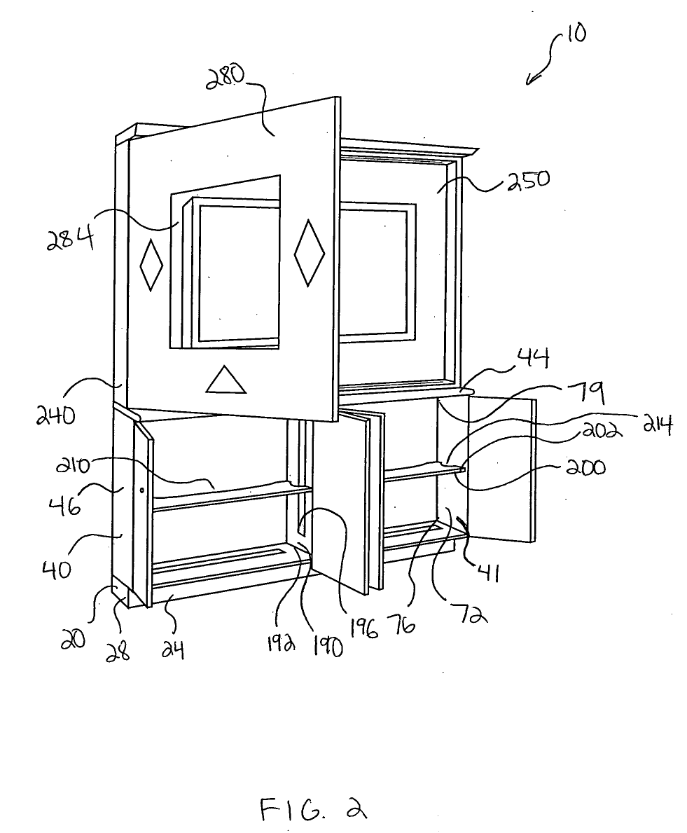

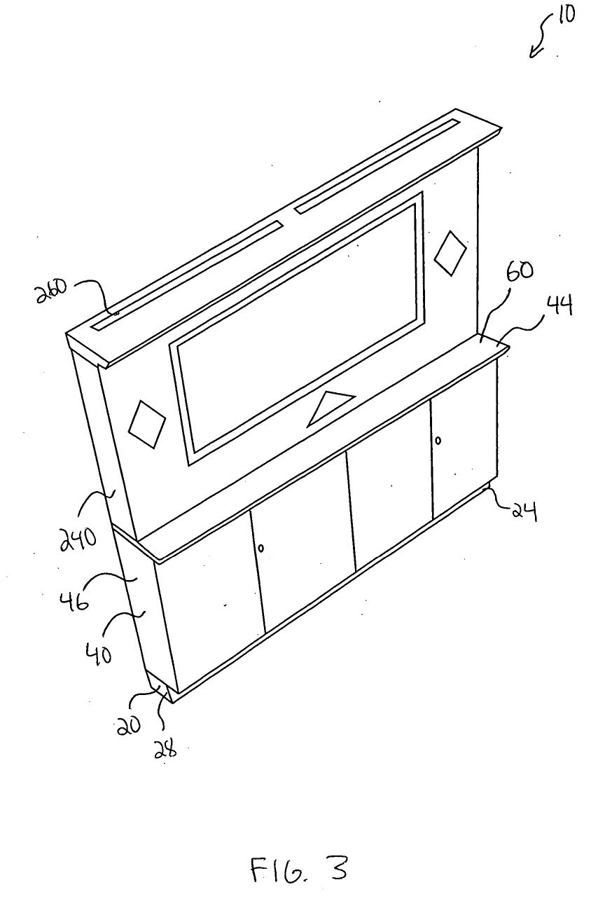

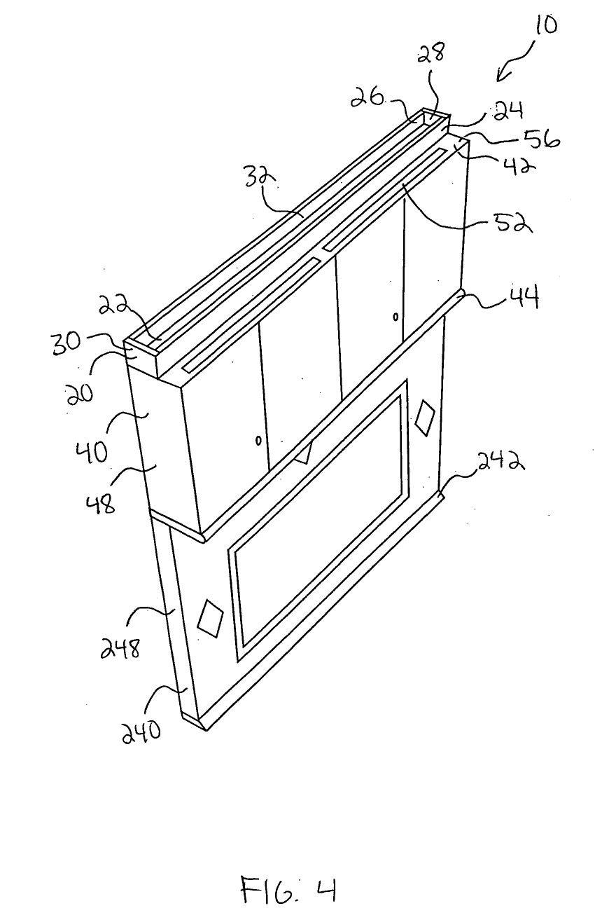

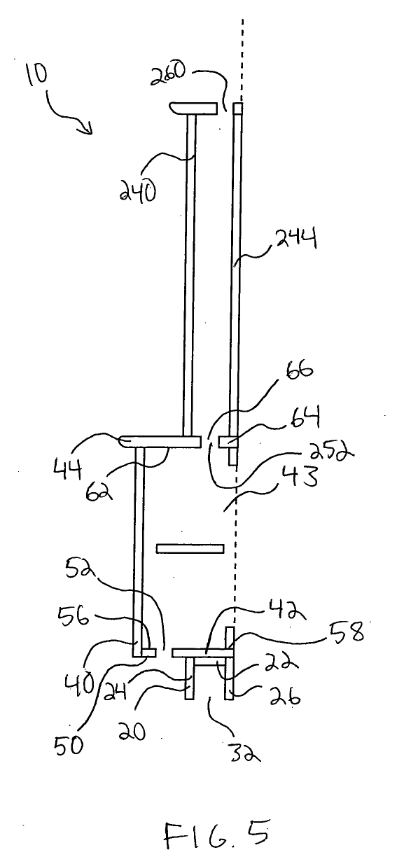

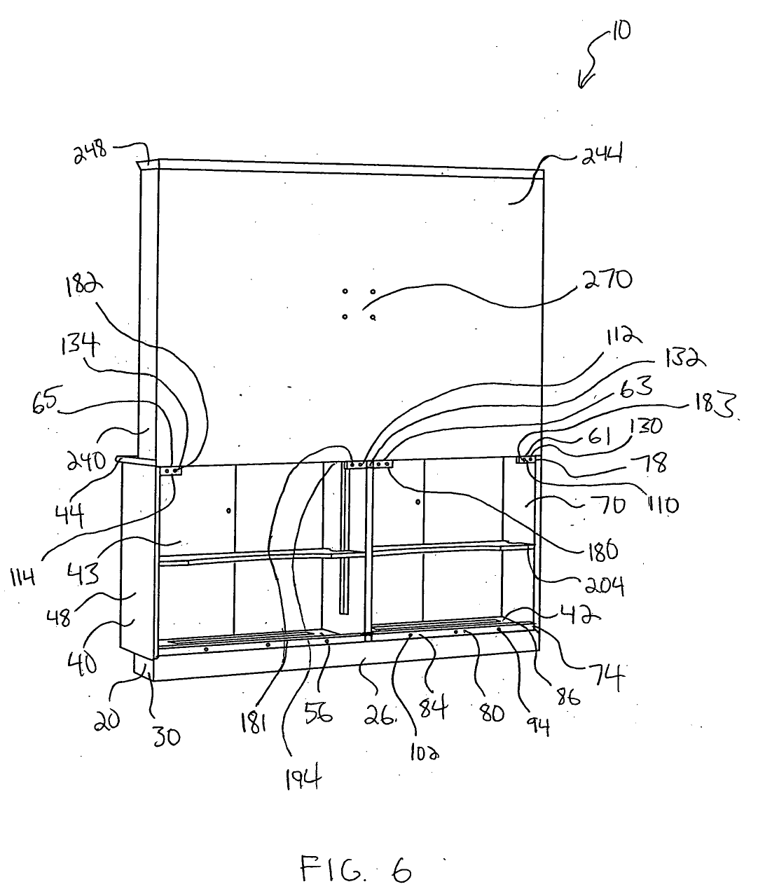

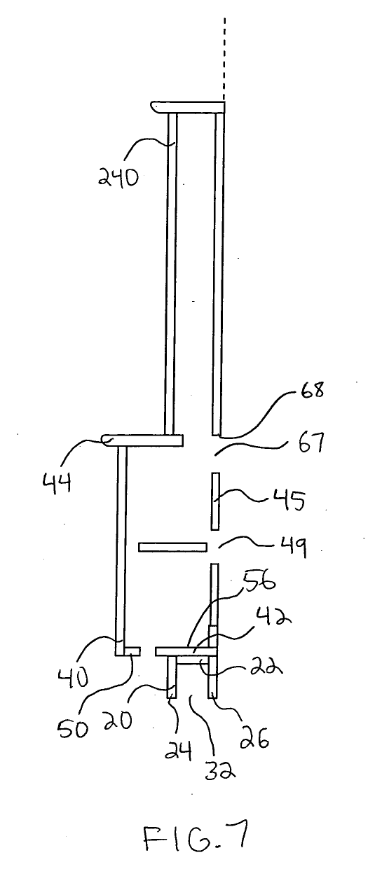

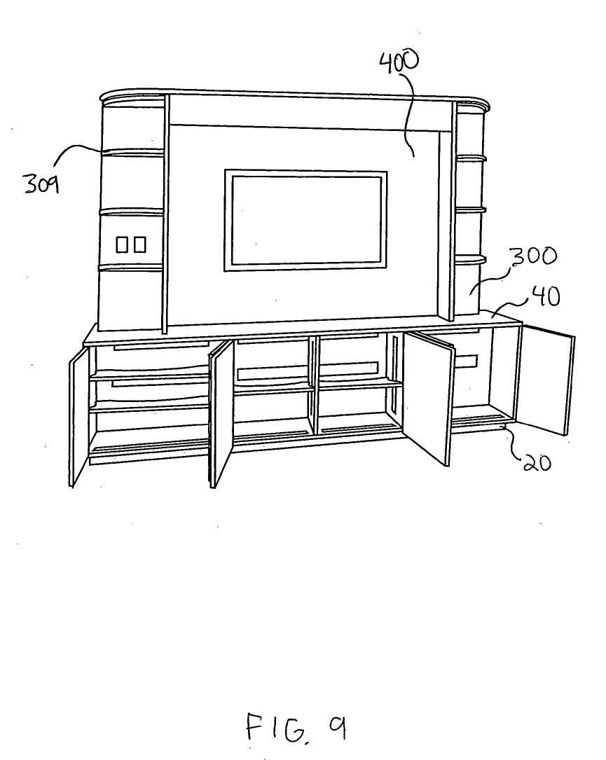

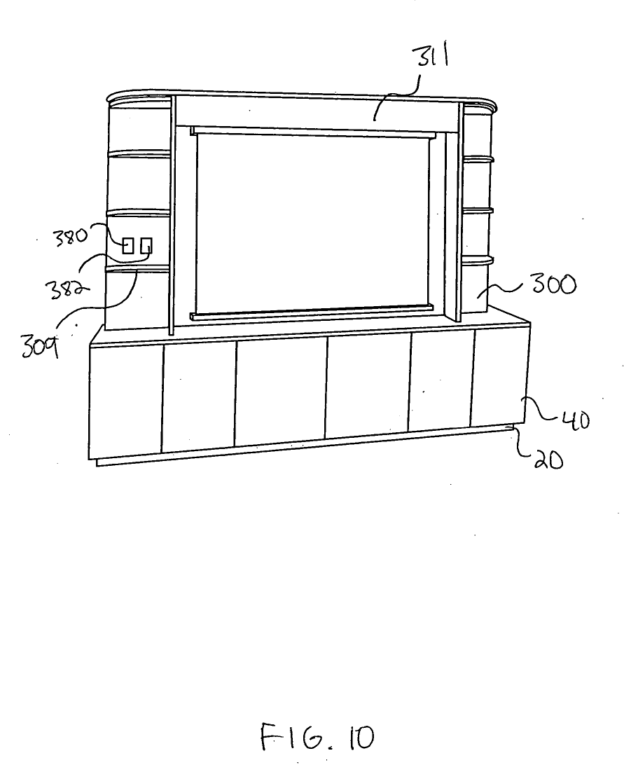

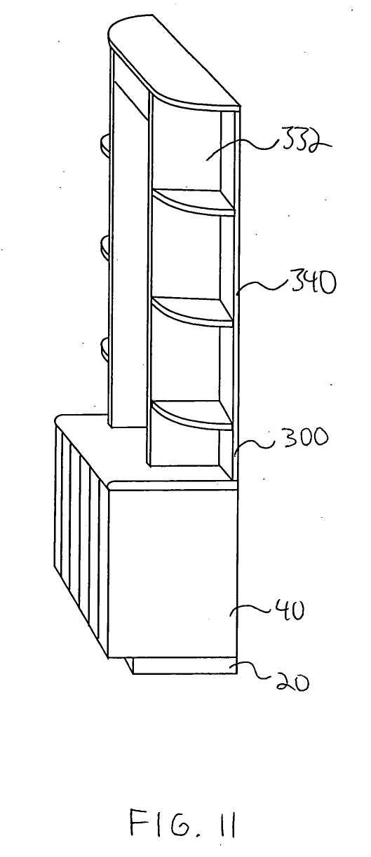

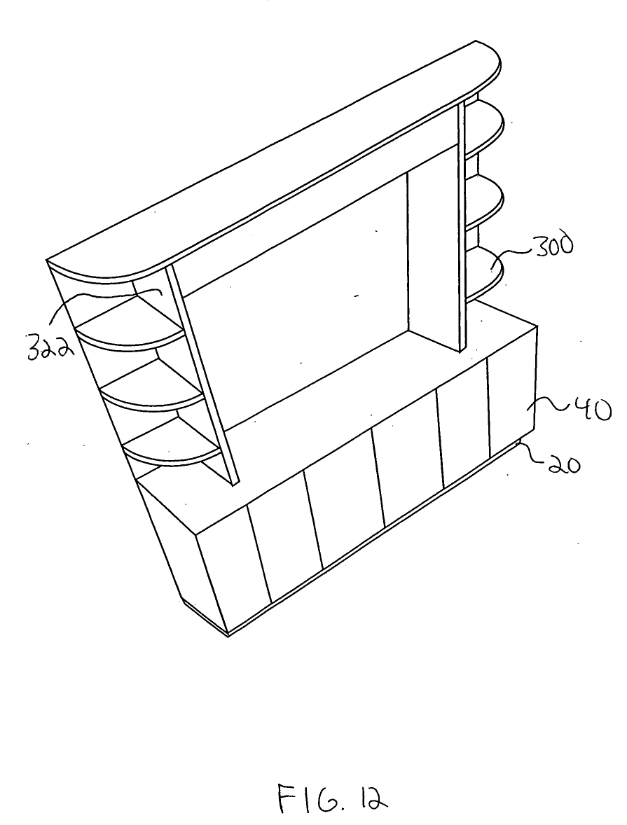

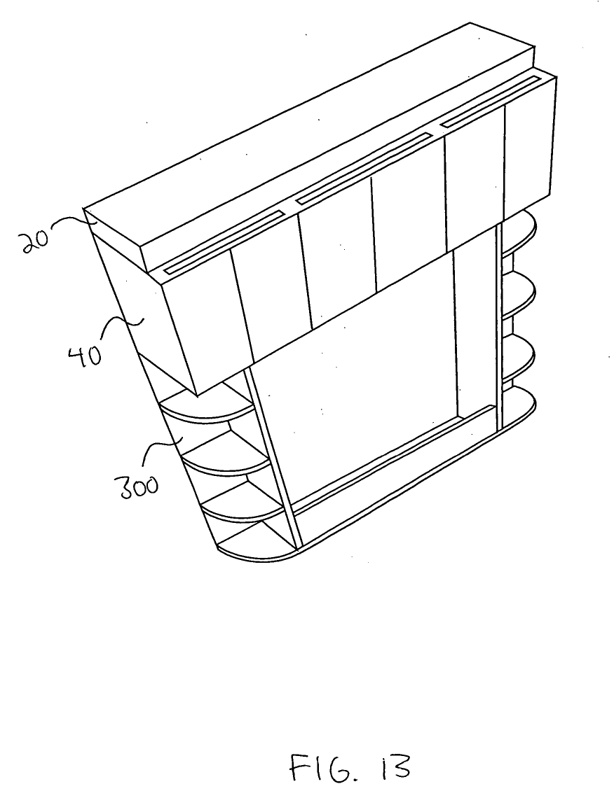

In describing the preferred and selected alternate embodiments of the present invention, as illustrated in FIGS. 1-15, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-8, the present invention in a preferred embodiment is an apparatus 10 for the storage, management and display of electronic equipment and devices, wherein apparatus 10 generally comprises base member 20, cabinet member 40 and hutch member 240. Preferably, base member 20 is substantially a rectangular-shaped block possessing top wall 22, front wall 24, rear wall 26, and sidewalls 28 and 30, wherein top wall 22, front wall 24, rear wall 26, and sidewalls 28 and 30 are affixed together by nails, screws, bolts, dowels, adhesive, or the like, to collectively form base member 20. Base member 20 preferably possesses open bottom 32; however, it is recognized that base member 20, in an alternate embodiment, could possess a solid bottom wall, wherein base member 20 would then effectively be a six-sided rectangular block. It is further recognized in an alternate embodiment that base member 20 could possess wheels to roll apparatus 10 across a ground surface.

It is contemplated that base member 20 and its component parts, in an alternate embodiment, could embody other suitable shapes and or sizes, so long as base member 20 is capable of supporting cabinet member 40 and hutch member 240 thereon, and so long as air is permitted to be convectively drawn through bottom cutouts formed through cabinet member 40, as more fully described below. Base member 20 is preferably formed from wood; however, it is recognized that base member 20 could be formed from other suitable materials, such as, for exemplary purposes only, high density particle board, metal, or other strong, rigid materials.

Preferably, cabinet member 40 is a hollow rectangular-shaped block having four walls and two open sides. Specifically, cabinet member 40 possesses bottom wall 42, top wall 44, sidewalls 46 and 48, open front side 41 and open rear side 43, wherein bottom wall 42, top wall 44, and sidewalls 46 and 48 are affixed together by nails, screws, bolts, dowels, adhesive, or the like, to collectively form cabinet member 40. It is recognized that cabinet member 40 and its component parts could alternatively embody other suitable shapes and/or sizes, so long as cabinet member 40 and its component parts are capable of convectively cooling stored electronic devices, as more fully described below. Cabinet member 40 is preferably formed from wood; however, it is contemplated that cabinet member 40 could be formed from other suitable materials, such as, for exemplary purposes only, high density particle board, metal, or other strong, rigid materials.

Bottom sides 47 and 48 (not shown) of sidewalls 46 and 48, respectively, of cabinet member 40 are preferably connected to top sides 29 and 31 (not shown) of sidewalls 28 and 30, respectively, of base member 20 by nails; however, it is recognized that other suitable fasteners could be utilized, such as, for exemplary purposes only, glues, rivets, bolts, screws, dowels, or the like. It is further contemplated that cabinet member 40 could be connected to base member 20 at alternately suitable connection points, or that base member 20 could be integrally formed to cabinet member 40, wherein base member 20 and cabinet member 40 could share a common horizontal wall, so long as air is permitted to be convectively drawn through bottom cutouts formed through cabinet member 40, as more fully described below.

Preferably, bottom wall 42 of cabinet member 40 is rectangular-shaped and comprises top side 56 and front portion 50, wherein front portion 50 possesses two equally spaced-apart rectangular cutouts 52. It is contemplated in an alternate embodiment that bottom wall 42 could possess any number and layout of cutouts 52, wherein cutouts 52 could embody any suitable shapes and/or sizes so long as cutouts 52 permit air to be convectively drawn into cabinet member 40, as more fully described below.

It is further contemplated in an alternate embodiment that base member 20 and cabinet member 40 could share a common horizontal wall at their connection point, so long as open air is permitted to be convectively drawn into cutouts 52, as more fully described below. Top side 56 of bottom wall 42 preferably functions as a shelf for supporting and storing electronics and other related devices for use with an audio visual display system. Top side 56 also preferably possesses rear portion 58 for receiving a securing block, as more fully described below.

Top wall 44 of cabinet member 40 is preferably rectangular-shaped and comprises top side 60, bottom side 62 and rear portion. 64, wherein rear portion 64 preferably possesses two equally spaced-apart rectangular cutouts 66. It is recognized that top wall 44 could possess any number and layout of cutouts 66, wherein cutouts 66 could embody any suitable shapes and/or sizes, so long as cutouts 66 provide a means for managing and organizing, electrical conductors, cables and/or wires, and so long as cutouts 66 permit air to ventilate out from cabinet member 40, as more fully described below.

Preferably, bottom side 62 possesses attachment sites 61, 63 and 65 for receiving securing blocks, as more fully described below, wherein attachment sites 61, 63 and 65 are positioned directly adjacent to open rear side 43, and wherein attachment site 61 is positioned adjacent to sidewall 46, attachment site 65 is positioned adjacent to sidewall 48, and attachment site 63 is positioned directly between sidewalls 46 and 48. Hutch member 240 is preferably mounted to top side 60, as more fully described below.

Sidewalls 46 and 48 of cabinet member 40 are preferably rectangular-shaped and permit the enclosure and retention of electronics and other related devices for use with an audio visual display system. Preferably, sidewalls 46 and 48 possess inner walls 70 and 72, respectively, wherein inner walls 70 and 72 possess lower attachment sites 74 and 76, respectively, and upper attachment sites 78 and 79, respectively, for receiving securing blocks, as more fully described below. Inner walls 70 and 72 also preferably possess a plurality of peg holes 71 (not shown) for purposes more fully described below.

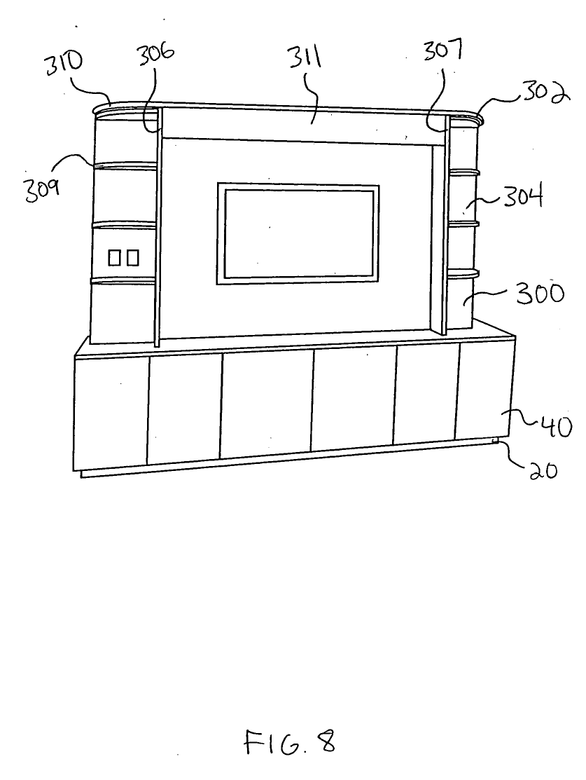

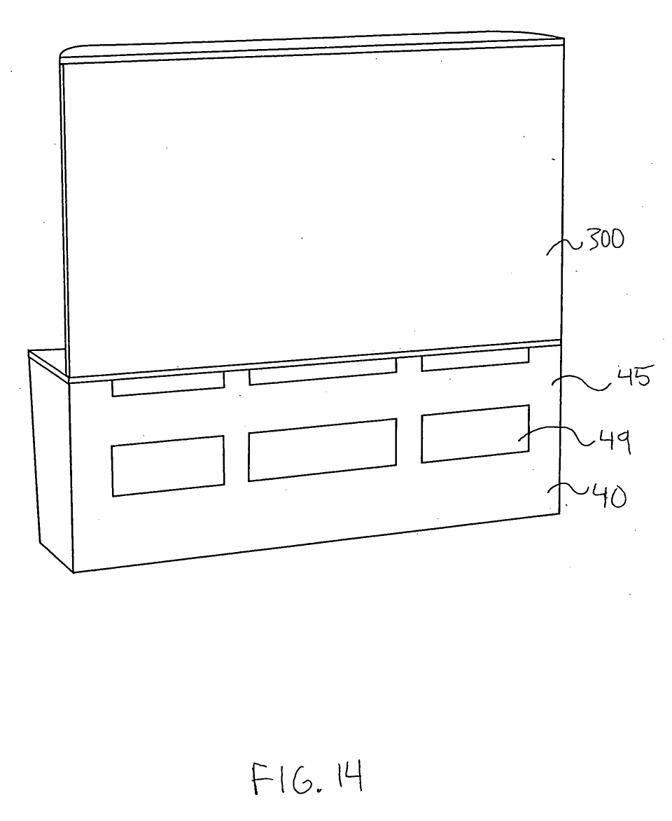

Rear side 43 of cabinet member 40 is preferably open, thereby enabling apparatus 10 to stand flush against a wall surface without having to accommodate for electrical outlets and/or electrical plugs. However, it is recognized that cabinet member 40 could alternatively possess solid rear wall 45, wherein solid rear wall 45 is rectangular-shaped and encloses and retains electronics and other related devices for use with an audio visual display system within cabinet member 40. As best seen in FIG. 14, rear wall 45 possesses three vertical columns of cutouts 49, wherein each column possesses two rectangular cutouts 49; however, it is recognized that rear wall 45 could possess any number and layout of any sized and shaped cutouts 49, so long as cutouts 49 function to manage cables and/or wires and permit convective airflow within cabinet member 40. Now referring to FIG. 8, it is further contemplated in another alternate embodiment that at least one cutout 49 on rear wall 45 and at least one cutout 66 on top wall 44 could be combined to form at least one cutout 67, wherein at least one cutout 67 is disposed on horizontal edge 68 formed between rear side 43 and top wall 44.

Cabinet member 40 also preferably possesses wooden rectangular securing blocks 80, 110, 112 and 114. It is recognized that securing blocks 80, 110, 112 and 114 could alternatively embody other suitable shapes and/or sizes and could be formed from other alternatively suitable materials, so long as securing blocks 80, 110, 112 and 114 are preferably capable of securing cabinet member 40 to a wall surface, as more fully described below. It is further contemplated that cabinet member 40 could possess any number of securing blocks situated at any position on cabinet member 40, so long as apparatus 10 is stable enough to firmly stand in place without significant tilt or lean.

Preferably, securing block 80 is an elongated rectangular block having front side 82 (not shown), rear side 84, top side 86, bottom side 88 (not shown), left side 90 (not shown) and right side 92 (not shown), wherein bottom side 88 is mounted to rear portion 58 of bottom wall 42 of cabinet member 40, left side 90 is mounted to lower attachment site 74 of sidewall 46 of cabinet member 40, and right side 92 is mounted to lower attachment site 76 of sidewall 48 of cabinet member 40. Securing block 80 is preferably secured to cabinet member 40 by nails; however it is recognized that other suitable fasteners could be utilized, such as, for exemplary purposes only, glue, screws, bolts, rivets, dowels, or the like.

Preferably, formed within securing block 80 are six equally spaced-apart channels 94, wherein channels 94 form apertures 96 (not shown) and recesses 98 (not shown) on front side 82 of securing block 80 for receiving mounting screws therein, and wherein channels 94 form apertures 102 on rear side 84 of securing block 80 for securing cabinet member 40 to a wall surface. Although it is preferred that screws be utilized to attach securing block 80 to a wall surface, it is recognized that other alternatively suitable fasteners could be utilized, such as, for exemplary purposes only, nails, bolts, rivets, anchors, brackets, or the like. Further, although it is preferred that securing block 80 possess six equally spaced-apart channels 94, it is recognized that securing block 80 could possess any number of channels 94 situated at any position on securing block 80, so long as apparatus 10 is stable enough to firmly stand in place without significant tilt or lean.

Preferably, securing blocks 110, 112 and 114 are rectangular blocks having front sides 120, 122 and 124 (not shown), respectively, rear sides 130, 132 and 134, respectively, top sides 140, 142 and 144 (not shown), respectively, bottom sides 150, 152 and 154 (not shown), respectively, left sides 160, 162 and 164 (not shown), respectively, and right sides 170, 172 and 174 (not shown), respectively. Preferably, left side 160 of securing block 110 is mounted to attachment site 78 of sidewall 46, top side 140 of securing block 110 is mounted to attachment site 61 of top wall 44; top side 142 of securing block 112 is mounted to attachment site 63 of top wall 44; and, right side 174 of securing block 114 is mounted to attachment site 79 of sidewall 48, and top side 144 of securing block 114 is mounted to attachment site 65 of top wall 44. Securing blocks 110, 112 and 114 are preferably secured to cabinet member 40 by nails; however it is recognized that other suitable fasteners could be utilized, such as, for exemplary purposes only, glue, screws, bolts, rivets, dowels, or the like.

Preferably formed within securing blocks 110, 112 and 114 are equally spaced-apart channels 180 and 181, wherein channels 180 and 181 form apertures 182 and 183, respectively, and recesses 184 and 185 (not shown), respectively, on front sides 120, 122 and 124 of securing blocks 110, 112 and 114, respectively, for receiving mounting screws therein, and wherein channels 180 and 181 form apertures 188 and 189 (not shown), respectively, on rear sides 130, 132 and 134 of securing blocks 110, 112 and 114, respectively, for securing cabinet member 40 to a wall surface. Although it is preferred that screws be utilized to attach securing blocks 110, 112 and 114 to a wall surface, it is recognized that other suitable fasteners could be utilized, such as, for exemplary purposes only, nails, bolts, rivets, anchors, brackets, or the like. Further, it is recognized that securing blocks 110, 112 and 114 could possess any number of channels, situated at any position on securing blocks 110, 112 and 114, so long as apparatus 10 is stable enough to firmly stand in place without significant tilt or lean.

Preferably, cabinet member 40 also possesses wooden vertical divider 190, wherein vertical divider 190 comprises first end 192 and second end 194. Vertical divider 190 is preferably substantially centered between sidewall 46 and 48, wherein first end 192 is preferably affixed to bottom wall 42, and wherein second end 194 is preferably affixed to top wall 44. It is recognized that cabinet member 40, in an alternate embodiment, could possess any number of vertical dividers 190 and that vertical dividers 190 could be located at any vertical position within cabinet member 40. Vertical divider 190 is preferably affixed to top wall 44 by nails; however, it is recognized that other suitable fasteners could be utilized, such as, for exemplary purposes only glue, brackets, grooves, screws, rivets, bolts, dowels, or the like. It is further contemplated that vertical divider 190 could be formed from other alternatively suitable materials and could embody other suitable shapes and/or sizes, so long as vertical divider 190 is capable of supporting shelves, as more fully described below.

Preferably, vertical divider 190 possesses substantially centered rectangular cutout 196. It is recognized that cutout 196 could alternatively embody other suitable shapes and/or sizes, so long as cutout 196 assists convective airflow within cabinet member 40. It is further contemplated that vertical divider 190 could alternatively possess any number of cutouts 196, and that cutout 196 could be located anywhere along vertical divider 190. Vertical divider 190 also preferably possesses a plurality of peg holes 71 (not shown) for purposes more fully described below.

Preferably, cabinet member 40 also possesses at least one shelf 200, wherein shelf 200 is substantially rectangular-shaped and comprises front end 202, back end 204, left end 206 (not shown) and right end 208 (not shown). It is recognized that shelf 200 could be formed from alternatively suitable materials and could embody alternate shapes and/or sizes, so long as shelf 200 is capable of supporting electronics and other related devices for use with an audio-visual display system thereon, and so long as shelf 200 assists convective airflow within cabinet member 40, as more fully described below. For example, shelf 200, in an alternate embodiment, could be a grid or mesh panel.

Preferably, semi-circle cutouts 210, 212 and 214 are substantially centered on back end 204, left end 206 and right end 208, respectively, of shelf 200. It is recognized that cutouts 210, 212 (not shown) and 214 could alternatively embody other suitable shapes and/or sizes, so long as cutouts 210, 212 and 214 assist convective airflow within cabinet member 40. Furthermore, it is contemplated that shelf 200 could alternatively possess any number of cutouts, wherein the cutouts could be located anywhere on shelf 200 and in any selected configuration/pattern.

Preferably, at least one shelf 200 is removably secured between vertical divider 190 and sidewall 46 and/or between vertical divider 190 and sidewall 48, wherein at least one shelf 200 is slideably engaged and supported therebetween by a plurality of support pegs 220 (not shown) retained within and extending from peg holes 71 (not shown), as is known within the art. Preferably, vertical divider 190 and inner walls 70 and 72 of sidewalls 46 and 48, respectively, each possess four vertically-aligned, equally spaced-apart, and horizontally-disposed pairs of peg holes 71, wherein each pair of peg holes 71 is horizontally aligned with a corresponding pair of peg holes 71, either on vertical divider 190, sidewall 46 or sidewall 48, and wherein the peg hole system functions to removably support and secure at least one shelf 200 between vertical divider 190 and sidewall 46 and/or between vertical divider 190 and sidewall 48.

It is contemplated in an alternate embodiment that vertical divider 190 and inner walls 70 and 72 could comprise any number and layout of peg holes 71 to facilitate support of any selected number of shelves 200 on and by pegs 220 extending from peg holes 71. Furthermore, although it is preferred that cabinet member 40 utilize support pegs 220 to removably support and secure any selected number of shelves 200 thereon, it is recognized that other alternatively suitable supports could be utilized, such as, for exemplary purposes only, glue, brackets, grooves, rails, nails, screws, bolts, rivets, dowels, and the like.

Front side 41 of cabinet member 40 is preferably open to facilitate receipt and retention of electronics and other related devices therein, wherein front side 41 preferably possesses doors 230, 232, 234 and 236. Doors 230, 232, 234 and 236 are preferably rectangular-shaped and formed from wood; however it is recognized that doors 230, 232, 234 and 236 could be formed from other suitable materials, such as, for exemplary purposes only, glass, high density particle board, or metal, and that doors 230, 232, 234 and 236 could alternatively embody other suitable shapes and/or sizes, so long as doors 230, 232, 234 and 236 function to enclose and retain electronics and other related devices therein for use with an audio-visual display system within cabinet member 40, or otherwise. Preferably, doors 230, 232, 234 and 236 are identically-sized and identically-shaped, wherein doors 230, 232, 234 and 236 extend from bottom wall 42 to top wall 44; however, it is contemplated that cabinet member 40 could possess any number and layout of doors. Preferably, doors 230, 232, 234 and 236 are pivotally mounted to front side 41 by a pair of hinges 240 (not shown), wherein hinges 240 are any suitable door hinges known within the art, so long as hinges 240 are capable of pivotally mounting doors 230, 232, 234 and 236 to cabinet member 40 to permit the opening and closing of same.

Hutch member 240 preferably generally comprises top wall 242, rear wall 244, and sidewalls 246 and 248, wherein top wall 242, rear wall 244, and sidewalls 246 and 248 are affixed together by nails, screws, bolts, dowels, adhesive, or the like, to collectively form hutch member 240. Hutch member 240 preferably possesses open front side 250 and open bottom side 252, wherein open bottom side 252 is mounted over cutouts 66 of cabinet member 40; however, it is contemplated in an alternate embodiment that hutch member 240 could comprise a solid bottom wall (not shown), so long as the bottom wall possesses at least one cutout (not shown) for accommodating cutouts 66 of cabinet member 40. Furthermore, it is contemplated that hutch member 240 and its component parts could alternatively embody other suitable shapes and/or sizes, so long as hutch member 240 and its component parts are capable of convectively cooling electronic devices stored therein, as more fully described below.

Hutch member 240 is preferably formed from wood; however, it is recognized that hutch member 240 could be formed from other alternatively suitable materials, such as, for exemplary purposes only, high density particle board, metal, or other strong, rigid materials. Preferably, hutch member 240 is mounted to cabinet member 40 by wood screws; however, it is contemplated that other alternatively suitable attachment means known within the art could be employed, such as, for exemplary purposes only, a peg and peg hole system, a groove system, brackets, nails, bolts, rivets, dowels, and the like.

Preferably, top wall 242 of hutch member 240 is rectangular-shaped and possesses two equally spaced-apart rectangular cutouts 260. It is contemplated that top wall 242 could possess any number and layout of cutouts 260, wherein cutouts 260 could embody any suitable size or shape, so long as cutouts 260 permit air to ventilate out from hutch member 240, as more fully described below. It is further contemplated in an alternate embodiment that top wall 242 could embody other suitable shapes and/or sizes, or that hutch member 240 could lack top wall 242.

Preferably, rear wall 244 of hutch member 240 is rectangular-shaped; however, it is contemplated in an alternate embodiment that rear wall 244 could embody other suitable shapes and/or sizes, or that hutch member 240 could lack rear wall 244. Preferably disposed and generally centered on rear wall 244 are mounting holes 270, wherein mounting holes 270 are configured to receive mounting plate 272 (not shown) and mounting screws 274 (not shown). Mounting plate 272 is preferably a plate or bracket for securing a plasma display screen to a wall surface. Mounting screws 274 preferably function to secure a plasma display screen to mounting plate 272, mounting plate 272 to rear wall 244, and rear wall 244 to a wall surface.

Sidewalls 246 and 248 of hutch member 240 are preferably rectangular-shaped and permit the enclosure and retention of a plasma display screen within hutch member 240. Front side 250 of hutch member 240 is preferably open to receive and retain a plasma display screen therein, wherein front side 250 preferably possesses door 280. Door 280 is preferably generally rectangular-shaped and formed from wood; however it is recognized that door 280 could be formed from other suitable materials and could embody other suitable shapes and/or sizes, so long as door 280 functions to enclose and retain a plasma display screen within hutch member 240. It is further recognized that front side 250 could alternatively possess any number of doors. Preferably, door 280 is pivotally mounted to front side 250 of hutch member 240 by a pair of hinges 282 (not shown). Preferably, hinges 282 are any suitable door hinges known within the art, so long as hinges 282 are capable of pivotally mounting door 280 to hutch member 240 to permit the opening and closing of same.

Cutout 284 is preferably disposed and centered on door 280, wherein the size and shape of cutout 284 preferably depends on the size and shape of the plasma screen to be displayed, and wherein a larger cutout 284 is provided to display a larger plasma screen. In addition, speakers 281, 283 and 285 (not shown) are preferably mounted to inner wall 288 (not shown) of door 280, wherein door 280 preferably possesses cutouts 290, 292 and 294 to permit sound generated by speakers 281, 283 and 285 to exit hutch member 240. Preferably, speakers 281, 283 and 285 are mounted directly beneath cutouts 290, 292 and 294, respectively, to permit maximum sound quality; however, it is recognized that any number of speakers could be positioned anywhere within hutch member 240. It is further contemplated in an alternate embodiment that door 280 could possess any number and layout of cutouts wherein the cutouts could embody any suitable shapes/and or sizes so long as the cutouts preferably permit sound generated by speakers 281, 283 and 285 to exit hutch member 240.

Preferably, apparatus 10 is an air-ventilated apparatus for the storage and/or display of electronic devices, wherein cool air is convectively moved through apparatus 10 and over the electronic devices stored therein, thereby prolonging the life of the stored electronic devices by reducing/eliminating the occurrence of overheating. More specifically, cool, dense air is preferably convectively drawn into apparatus 10 through lower cutouts 52, wherein the cool air is preferably convectively drawn over the electronic devices stored within cabinet member 40. Warm air produced by the stored electronic components is permitted to rise and preferably ventilate out of cabinet member 40 through upper cutouts 66. Cabinet member 40 also preferably possesses cutout 196 on vertical divider 190 and cutouts 210, 212 and 214 on shelf 200 for optimal airflow within cabinet member 40. Furthermore, cutouts 52 are preferably positioned at the bottom front of cabinet member 40, and cutouts 66 are preferably positioned at the top rear of cabinet member 40 to maximize airflow over a greater area within cabinet member 40. Cooler air is also preferably convectively drawn into hutch member 240 through bottom side 252, wherein cooler air is convectively drawn over the stored electronic devices, and wherein the warmer, lighter air produced by the electronic devices ventilates out of hutch member 240 through cutouts 260.

Now referring to FIGS. 8-14, hutch member 300, in an alternate embodiment, generally comprises top wall 302, rear wall 304, sidewalls 306 and 307, shelves 309, and valence 311, wherein top wall 302, rear wall 304, sidewalls 306 and 307, shelves 309 and valence 311 are affixed together by nails, screws, bolts, dowels, adhesive, or the like, to collectively form hutch member 300. Hutch member 300 is formed from wood and is mounted to cabinet member 40 by wood screws, nails, bolts, dowels, adhesive, or the like.

Top wall 302 is generally rectangular-shaped and possesses rounded front corners 310. Sidewalls 306 and 307 are rectangular-shaped and have rear edges 320 and 330 (not shown), respectively, and outer surfaces 322 and 332, respectively. Rear wall 304 is rectangular-shaped and comprises top edge 321 (not shown), left edge 330 (not shown) and right edge 340. Rear edge 320 of sidewall 306 is affixed to rear wall 304, wherein sidewall 306 is situated approximately 1.5 feet from left edge 330 of rear wall 304. Rear edge 330 of sidewall 307 is affixed to rear wall 304, wherein sidewall 307 is situated approximately 1.5 feet from right edge 340 of rear wall 304.

Affixed to outer surfaces 322 and 332 of sidewalls 306 and 307, respectively, are three equally spaced apart shelves 309, wherein shelves 309 are triangle-shaped and comprise first edge 350 (not shown) and second edge 360 (not shown), wherein first edge 350 is mounted to rear wall 304, and wherein second edge 360 is selectively mounted to sidewall 306 or 307.

Rear wall 304 possesses circular cutouts 370 and 372 (not shown), and rectangular cutouts 380 and 382 (not shown), wherein circular cutouts 370 and 372 permit managing of cables and/or wires therethrough, and wherein rectangular cutouts 380 and 382 are provided to receive auxiliary control panels and/or electrical outlets. Cutouts 370 and 372 are positioned proximate to top edge 320 of rear wall 304, wherein cutout 370 is positioned proximate to sidewall 306, and wherein cutout 372 is positioned proximate to sidewall 307. Cutouts 380 and 382 are horizontally aligned and positioned adjacent to sidewall 306, wherein cutouts 380 and 382 are situated directly above a first lower shelf 309.

Valence 311 is a rectangular-shaped wooden board for concealing a projector screen, light fixtures, and/or other selected electronic devices and equipment. Valence 311 comprises first edge 392, second edge 394 and third edge 396 (not shown), wherein first edge 392 is affixed to top wall 302, second edge 394 is affixed to sidewall 306, and third edge 396 is affixed to sidewall 307. Rear wall 304 also possesses open section 400, wherein section 400 is situated below top wall 302 and between sidewalls 306 and 307, and wherein section 400 provides an area for mounting an electronic whiteboard, a plasma screen, or other selected display screen.

In another alternate embodiment, apparatus 10 could embody a single structure having cabinet shelves, cabinet doors, and a means for displaying a display screen; wherein the single unitary structure possesses at least one cutout, at least one middle cutout, and at least one upper cutout for managing cables and convectively cooling stored electronic devices.

In yet another alternate embodiment, apparatus 10 could comprise any number of base members 20, cabinet members 40 and hutch members 240.

In yet another alternate embodiment, any number and layout of cutouts could be disposed on sidewalls 46, 48, 246 and/or 248, and/or doors 230, 232, 234, 236, and/or 280.

In still another alternate embodiment, cabinet member 40 and/or hutch member 240 could be configured to store and display more than one display screen.

In still another alternate embodiment, apparatus 10 could possess built-in power outlets, extension cords and/or lights.

In yet a further alternate embodiment, apparatus 10 could be configured to stand freely without the assistance of a wall or other support structure.

In still a further alternate embodiment, apparatus 10 could be formed from a semi-air-permeable, breatheable material.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. An apparatus for housing electronic devices, said apparatus comprising:
at least one first cutout disposed on said apparatus, said at least one first cutout permitting air to be convectively drawn therethrough and into said apparatus for cooling the electronic devices housed therewithin; and
at least one second cutout disposed on said apparatus, said at least one second cutout permitting the air to ventilate outwards therefrom.

2. The apparatus of claim 1, wherein said at least one second cutout is positioned above said at least one first cutout.

3. The apparatus of claim 1, wherein said at least one first cutout is positioned on a bottom wall of said apparatus.

4. The apparatus of claim 3, further comprising at least one base member disposed on said bottom wall of said apparatus, wherein said at least one base member elevates said apparatus a selected distance from a supporting base surface to permit cooler air to enter said at least one first cutout formed through said bottom wall of said apparatus.

5. The apparatus of claim 1, wherein said at least one first cutout is positioned at a front lower portion of said apparatus, and wherein said at least one second cutout is positioned at a rear upper portion of said apparatus, to maximize convective airflow over a greater area within said apparatus.

6. The apparatus of claim 1, wherein said at least one first cutout is positioned at a rear lower portion of said apparatus, and wherein said at least one second cutout is positioned at a front upper portion of said apparatus, to maximize convective airflow over a greater area within said apparatus.

7. The apparatus of claim 1, further comprising at least one divider, wherein said at least one divider comprises at least one cutout to maximize convective airflow within said apparatus.

8. The apparatus of claim 1, further comprising at least one shelf, wherein said at least one shelf comprises at least one cutout to maximize convective airflow within said apparatus.

9. The apparatus of claim 1, further comprising at least one rear aperture to accommodate the introduction of outlets, plugs and wires therethrough.

10. The apparatus of claim 1, further comprising at least one rear aperture to accommodate the introduction of outlets, plugs and wires therethrough to permit said apparatus to sit flush against a wall surface.

11. An apparatus for housing electronic devices, said apparatus comprising:
at least one first cutout disposed on said apparatus, said at least one first cutout permitting air to be convectively drawn therethrough and into said apparatus for cooling the electronic devices housed therewithin;
at least one second cutout disposed on said apparatus, said at least one second cutout permitting the air to ventilate outwards therefrom; and
at least one shelf comprising at least one cutout to maximize convective airflow within said apparatus.

12. The apparatus of claim 11, wherein said at least one second cutout is positioned above said at least one first cutout.

13. The apparatus of claim 11, wherein said at least one first cutout is positioned on a bottom wall of said apparatus.

14. The apparatus of claim 13, further comprising at least one base member disposed on said bottom wall of said apparatus, wherein said at least one base member elevates said apparatus a selected distance from a supporting base surface to permit cooler air to enter said at least one first cutout formed through said bottom wall of said apparatus.

15. The apparatus of claim 11, wherein said at least one first cutout is positioned at a front lower portion of said apparatus, and wherein said at least one second cutout is positioned at a rear upper portion of said apparatus, to maximize convective airflow over a greater area within said apparatus.

16. The apparatus of claim 11, wherein said at least one first cutout is positioned at a rear lower portion of said apparatus, and wherein said at least one second cutout is positioned at a front upper portion of said apparatus, to maximize convective airflow over a greater area within said apparatus.

17. The apparatus of claim 11, further comprising at least one divider, wherein said at least one divider comprises at least one cutout to maximize convective airflow within said apparatus.

18. The apparatus of claim 11, further comprising at least one rear aperture to accommodate the introduction of outlets, plugs and wires therethrough.

19. The apparatus of claim 11, further comprising at least one rear aperture to accommodate the introduction of outlets, plugs and wires therethrough to permit said apparatus to sit flush against a wall surface.

20. A method of housing electronic devices, said method comprising the steps of:
a. placing the electronic devices within an apparatus for housing electronic devices;
b. convectively cooling the electronic devices therein.

21. The method of claim 20, further comprising the step of permitting cooler air to be convectively drawn into said apparatus through at least one first cutout formed therethrough.

22. The method of claim 20, further comprising the step of permitting the cooler air to be convectively intermixed with heat released by the electronic devices, thereby yielding a warmer air.

23. The method of claim 22, further comprising the step of permitting the warmer air to convectively ventilate out of at least one second cutout, thereby cooling the electronic devices.

24. The method of claim 20, wherein convective cooling of the stored electronic devices is maximized by at least one divider, said at least one divider comprising at least one cutout.

25. The method of claim 20, wherein convective cooling of the stored electronic devices is maximized by at least one shelf, said at least one shelf comprising at least one cutout.

26. The method of claim 20, further comprising the step of passing and managing electrical conductors through at least one of said first and second cutouts.
